(19) United States
(12) Patent Application Publication
(10) Pub. No.: US 2013/0305324 A1
(43) Pub. Date: Nov. 14, 2013

(54) Incremental Password Barriers to Prevent Malevolent Intrusions

(71) Applicants: Jack Allen Alford, JR., Austin, TX (US); Scott Harlan Isensee, Austin, TX (US); James Lee Lentz, Austin, TX (US); Kelly Lorraine Lisai, Austin, TX (US)

(72) Inventors: Jack Allen Alford, JR., Austin, TX (US); Scott Harlan Isensee, Austin, TX (US); James Lee Lentz, Austin, TX (US); Kelly Lorraine Lisai, Austin, TX (US)

(73) Assignee: International Business Machines Corporation, Armonk, NY (US)

(21) Appl. No.: 13/467,096

(22) Filed: May 9, 2012

(51) Int. Cl. G06F 21/20

(52) U.S. Cl. 726/5

(57) ABSTRACT

According to one embodiment of the present invention, an approach is provided that, when an incorrect password during a sign-on attempt at a password prompt included in a sign-on barrier to a restricted resource (such as a locked mobile telephone), incrementally increases the sign-on barrier. The increased sign-on barrier includes can include additional prompts and/or a time delay. If subsequent responses match expected responses, then access to the restricted resource is provided to the user. However, if any of the subsequent responses fail to match a corresponding expected response, then access to the restricted device continues to be denied. Subsequent responses include further attempts at entering a correct password.

### TECHNICAL FIELD

The present invention relates to an approach that prevents malevolent intrusions to accounts by incrementally increasing password barriers when an incorrect password is entered.

### BACKGROUND OF THE INVENTION

Password cracking, or hacking, is the process of discovering passwords used to control access to a computer resource, such as a computer account. A common approach by malevolent users is to repeatedly try to guess the correct password. The time needed to crack a password is generally related to the password strength (which is a measure of the password's information entropy). One approach is referred to as “brute-force” cracking, in which a user or computer tries many possible passwords until finding one that is successful. While higher password strength increases the number of candidate passwords that must be checked, on average, to discover the password and reduces the likelihood that the password will be found in any cracking dictionary, such “strong passwords” are not always desirable, especially with a system that is frequently accessed, such as a mobile device (e.g., smart phone, personal digital assistant, laptop computer, etc.).

### SUMMARY

According to one embodiment of the present invention, an approach is provided that, when an incorrect password during a sign-on attempt at a password prompt included in a sign-on barrier to a restricted resource (such as a locked mobile telephone), incrementally increases the sign-on barrier. The increased sign-on barrier includes can include additional prompts and/or a time delay. If subsequent responses match expected responses, then access to the restricted resource is provided to the user. However, if any of the subsequent responses fail to match a corresponding expected response, then access to the restricted device continues to be denied. Subsequent responses include further attempts at entering a correct password.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting password entry at a device, such as a smart phone;

FIG. 4 is a flowchart depicting steps taken at the device to initially receive a password from a user;

FIG. 5 is a flowchart depicting steps taken at the device to receive the password and additional prompts from the user;

FIG. 6 is a flowchart depicting steps taken at the device to display a selected prompt and receive a response from the user; and

FIG. 7 is a flowchart depicting steps taken at the device to display additional prompts and receive corresponding responses from the user.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

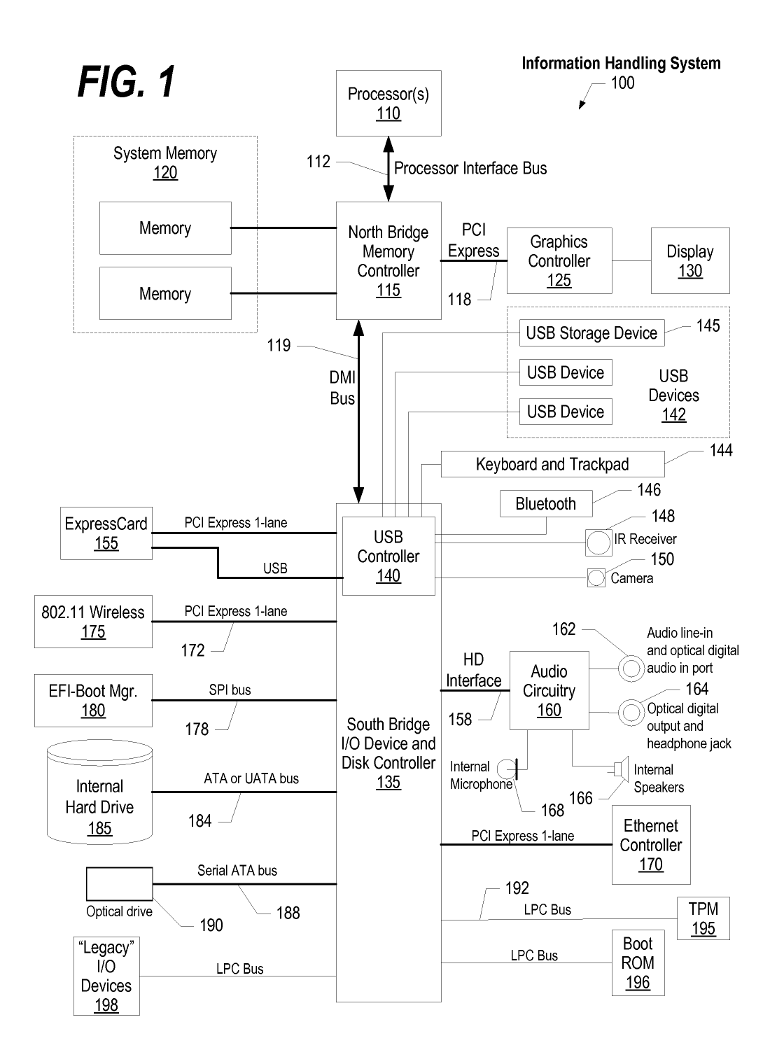

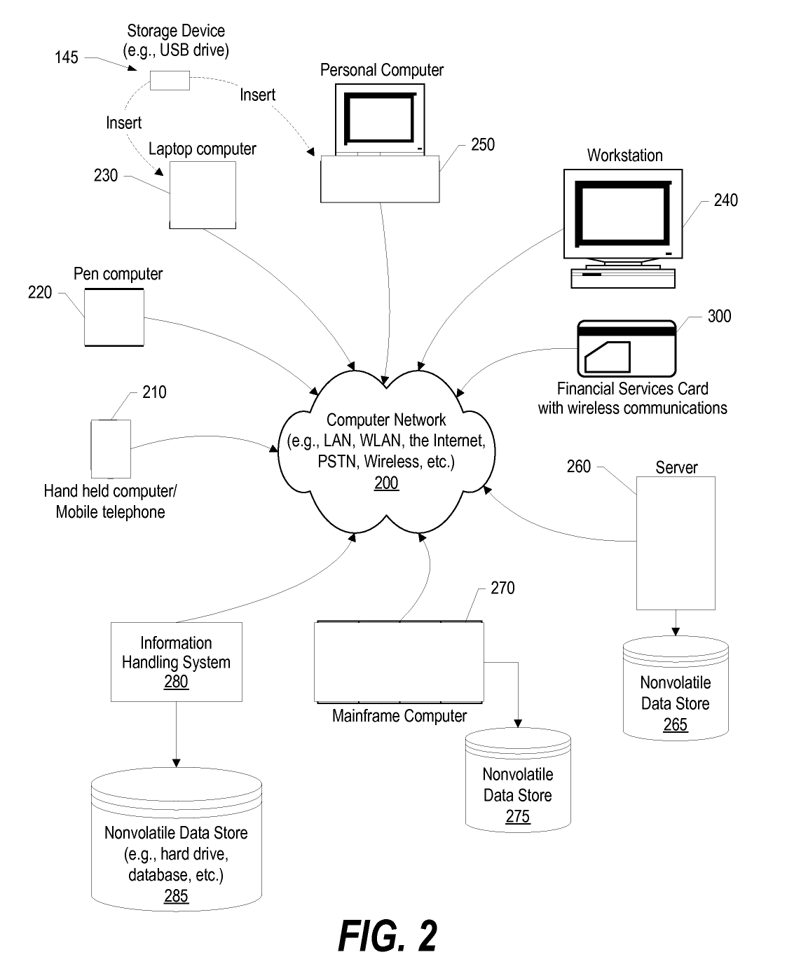

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

An approach is described in the Figures and description that follows that adds incrementally higher barriers to make it more time consuming and difficult to guess a password at a user's device, such as a mobile telephone. After each incorrect password attempt, the user (e.g., a thief, hacker, malevolent user, etc.) is blocked from trying to input another password until a period of time has passed. This time interval can become longer after further incorrect attempts. After a certain number of incorrect tries, the user must enter the answer to a prompt such as a question that the valid owner of the device has previously set (e.g., the user's Mother's maiden name, town in which the user lived at age 20, etc.). If either the password or the answer to the additional prompt is incorrect, the user is told that there is an error, but is not informed as to which input was incorrect. In this manner, the hacker will not know whether they got the password or the question wrong. Some of the questions will be presented in image form like a CAPTCHA. This ensures that a human must be reading and responding to the questions to eliminate the possibility of some sort of automated system (e.g., “bot,” etc.) being used to supply responses. Questions can also be generated based on past behaviors that only the user of the device would know such as the last application they installed, where the user has been recently (tracked by GPS data), where the user bought the device, etc. The device may require the user to apply patterns such as shaking the device in a unique way they have previously set. This can be detected using the motion sensors, such as accelerometers, that may mobile devices currently utilize with the movement pattern not being easily guessed and unavailable on a list of written passwords or the like. Input prompts may also include biometric checks such as voice recognition or taking a picture of the user's face with the camera and matching this with a stored image. Another security device that can be applied in combination is to use an external tag, such as an RFID chip, that the user would wear in a ring or somewhere else. The device would unlock only if this external tag was present in combination with entry of the password or other security input. These techniques of making an increasingly difficult sign-on barrier are directed at thwarting the efforts of a thief or malevolent user who has stolen or gained access to a device, such as a mobile telephone, to go through all the possible password combinations. Upon recovering the device, however, these time delays and questions do not pose a significant obstacle to the owner unlocking the device since they will have the information and only need to make a single try to unlock the device. In addition, because of increased security in a mobile device, such as a mobile smart phone, the user is more confident that data on the device will remain secure and avoid having to remotely wipe data from the device. In this manner, if the device is lost or stolen and later recovered, the user's data will remain securely on the device. Many of these techniques could be applied to desktop computers and software in the cloud as well as mobile devices. Similar techniques can be applied by the user of the device, when they have forgotten their password.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE. 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

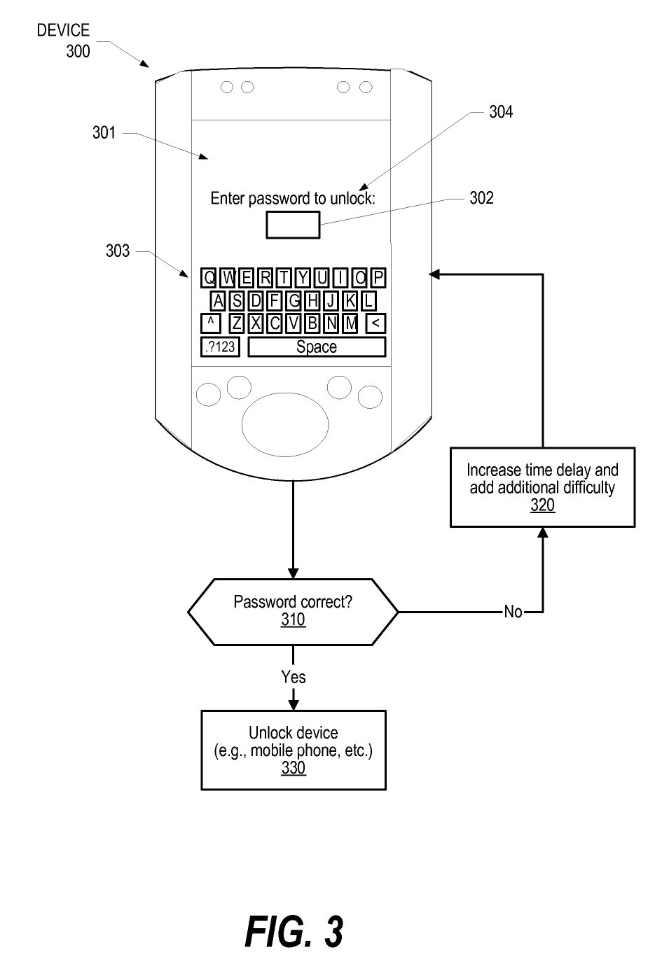

FIG. 3 is a diagram depicting password entry at a device, such as a smart phone. Device 300 is an information handling system such as the information handling system described in FIG. 1 or any of the information handling system described in connection with FIG. 2. In FIG. 3, device 300 is shown as a mobile information handling system, such as a mobile telephone. Device 300 is shown to include display screen 301, password input text box 302, and keypad 303 which serves as an input device. Keypad 303 can be a physical keypad or a touch-sensitive display keypad that is displayed on the display screen when needed. Password prompt 304 is displayed on display screen 301 and instructs the user to enter a password in order to unlock the device. In many mobile information handling systems, especially those with small form factors, the password is often shorter (e.g., four characters, etc.) than found in other systems that utilize passwords (e.g., Websites, email accounts, desktop computer systems, etc.). In order to thwart a malevolent user that may attempt a “brute force” attack on the device by entering many different combinations of possible passwords, the sign-on barrier is incrementally increased when an incorrect password is entered. Device 300 is an example of a restricted resource. Other examples might include a restricted website, an email account, a network-accessible software system, and the like. When a password is entered by a user of the device, a decision is made as to whether the password that was entered is the correct password (decision 310). If the password entered by the user is incorrect, then decision 310 branches to the “no” branch whereupon, at step 320, the sign-on barrier is incrementally increased (e.g., adding time delays, additional prompts, etc.) and processing loops back to receive the password and the additional information from the user. This looping continues with the sign-on barrier becoming increased (e.g., longer time delays, different or more difficult prompts, etc.) so long as any of the responses (e.g., to the password or the additional prompts) are incorrect. When the user's responses are correct (e.g., correct password, correct responses to prompts, etc.), then decision 310 branches to the “yes” branch whereupon, at step 330, access to the restricted resource is allowed (e.g., unlocking a mobile telephone, allowing access to a website, etc.).

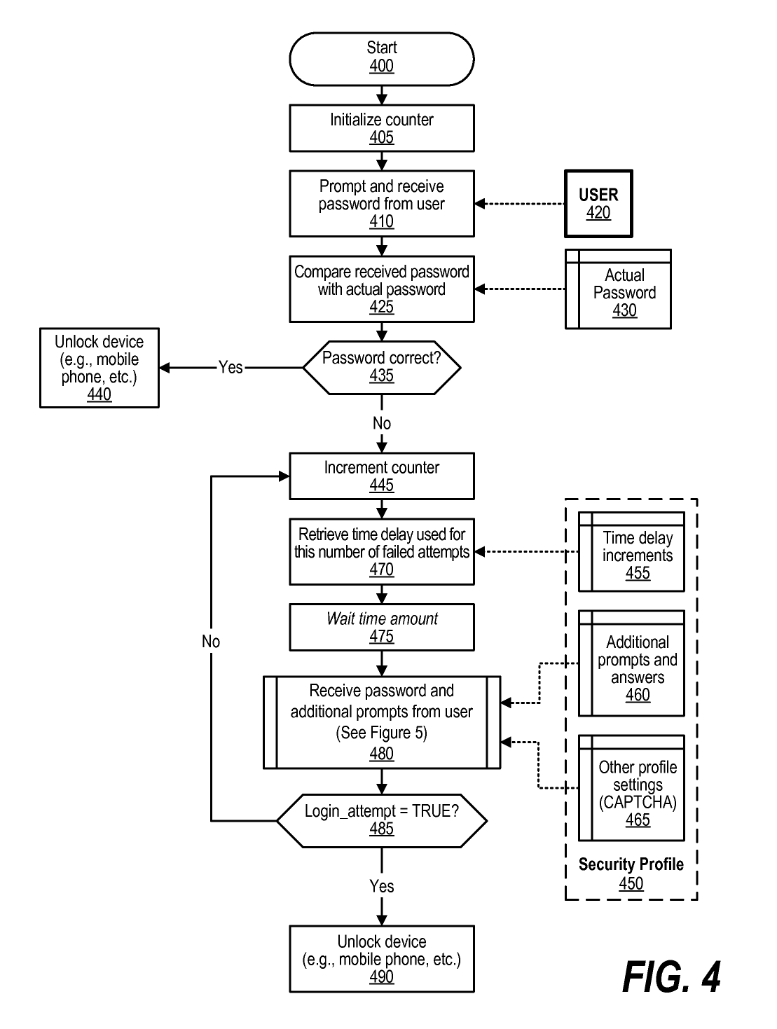

FIG. 4 is a flowchart depicting steps taken at the device to initially receive a password from a user. Processing commences at 400 whereupon, at step 405, the process initializes a counter that is used to keep track of how many incorrect password entry attempts have been made by the user. At step 410, a password prompt is displayed to the user and user 420 inputs a password. At step 425, the process compares the received password with an expected password that has been stored in memory area 430 (e.g., a memory inaccessible from outside of the restricted resource, etc.). A decision is made as to whether the password entered by the user is correct (decision 435). If the password entered by the user is correct, then decision 435 branches to the “yes” branch whereupon, at step 440, access to the restricted resource is allowed (e.g., unlocking a mobile phone, accessing a restricted website, etc.). On the other hand, if an incorrect password is received during the sign-on attempt at the password prompt that is included in the sign-on barrier to the restricted resource, then decision 435 branches to the “no” branch for further processing.

At step 445, the counter is incremented with the counter used to track the number of failed sign-on attempts that have been attempted. At step 470, a time delay (if any) is retrieved based on the number of failed sign-on attempts. The user may wish to have no time delay for one or two failed sign-on attempts as the user may occasionally mistype the password and may not wish to have a time delay when this occurs. At step 475, the system waits for the amount of time that was retrieved in step 470. For example, after two failed sign-on attempts the system may wait for two minutes after each sign-on attempt before continuing, after five failed sign-on attempts the system may wait for ten minutes after each sign-on attempt before continuing, and after ten failed sign-on attempts the system may wait for twenty minutes after each sign-on attempt before continuing.

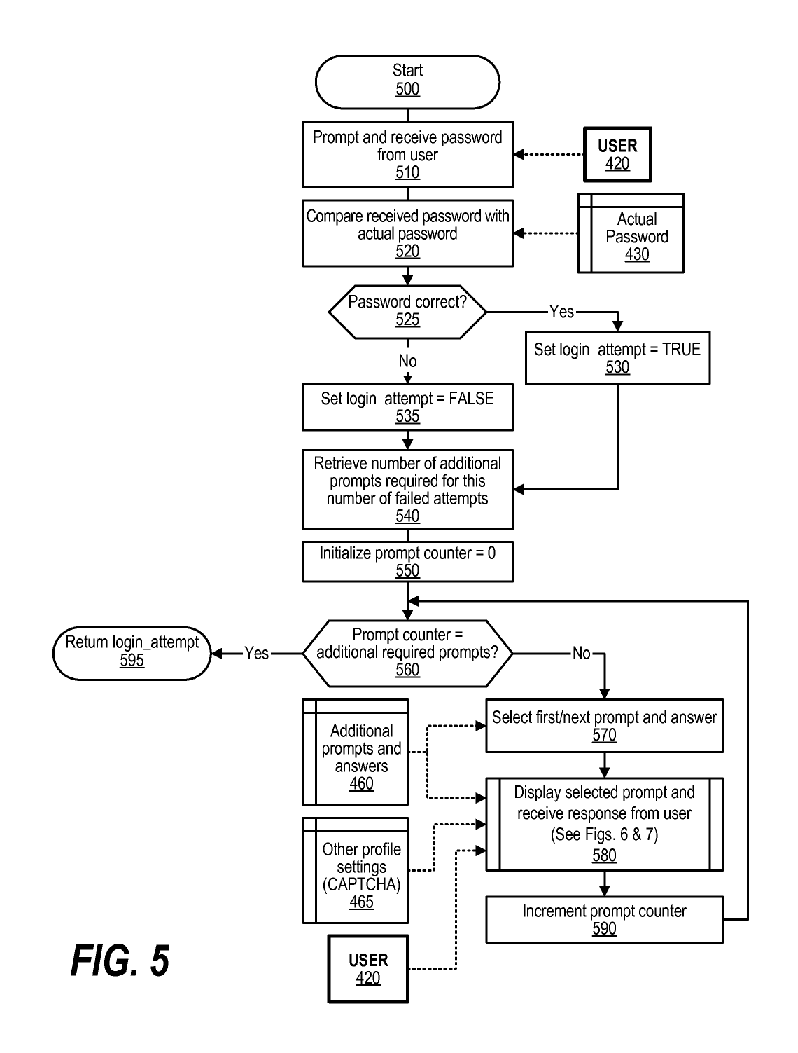

After the time delay has expired, at predefined process 480, the process receives the password from the user along with any additional responses to additional prompts that are utilized after the current number of failed sign-on attempts (see FIG. 5 and corresponding text for processing details). In addition, other profile settings indicate additional prompt data such as the user of a CAPTCHA, is retrieved and used during predefined process 480. After predefined process 480 has been performed and the user's responses to any additional responses has been evaluated, a decision is made (decision 485) as to whether the sign-on attempt has been successfully answered by the user (indicated by the Login_attempt being “TRUE”). If the user has provided correct responses to the password request and any additional prompts, then decision 485 branches to the “yes” branch whereupon at step 490, access to the restricted resource is allowed (e.g., unlocking a mobile phone, accessing a restricted website, etc.). On the other hand, if any of the responses are incorrect, then decision 485 branches to the “no” branch which loops back to increment the counter, retrieve whatever time delay corresponds to the counter value and wait for the amount of time to elapse, and retrieve the password and additional prompts corresponding to the incremented number of failed sign-on attempts. This looping continues, with time delays possibly becoming much longer and additional prompts possibly being different and more difficult to answer until the correct responses are received.

FIG. 5 is a flowchart depicting steps taken at the device to receive the password and additional prompts from the user. This process describes the details of predefined process 480 shown in FIG. 4 for receiving the password and additional responses from the user. In FIG. 5, processing commences at 500 whereupon, at step 510, a password prompt is redisplayed to the user and user 420 re-enters a password response. At step 520, the process compares the received password with an expected password that has been stored in memory area 430 (e.g., a memory inaccessible from outside of the restricted resource, etc.). A decision is made as to whether the password entered by the user is correct (decision 525). If the password entered by the user is correct, then decision 525 branches to the “yes” branch whereupon, at step 530, a flag (Login_attempt) is set to “TRUE” indicating that, so far, the user has responded to all prompts correctly. However, If the password entered by the user is incorrect, then decision 525 branches to the “no” branch whereupon, at step 535, the same flag (Login_attempt) is set to “FALSE” indicating that the user has provided an incorrect response.

At step 540, the process retrieves the number of additional prompts that are to be used for the current number of failed sign-on attempts. At step 550, a prompt counter is initialized to zero. A decision is made as to whether the prompt counter is equal to the number of additional prompts that are used for the current number of failed sign-on attempts (decision 560). If the prompt counter is equal to the number of additional prompts that are used for the current number of failed sign-on attempts, then decision 560 branches to the “yes” branch whereupon, at step 595, processing returns the login_attempt flag to the calling routine (see FIG. 4 for handling of the returned login_attempt flag). On the other hand, if the prompt counter is not equal to the number of additional prompts that are used for the current number of failed sign-on attempts, then decision 560 branches to the “no” branch for further processing.

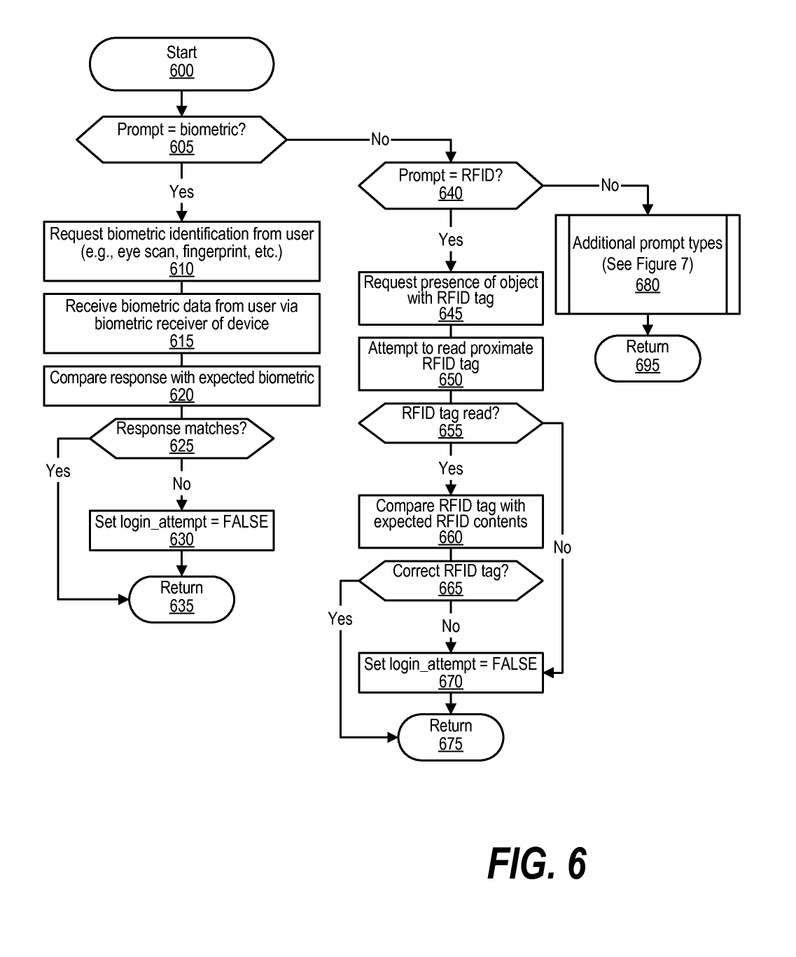

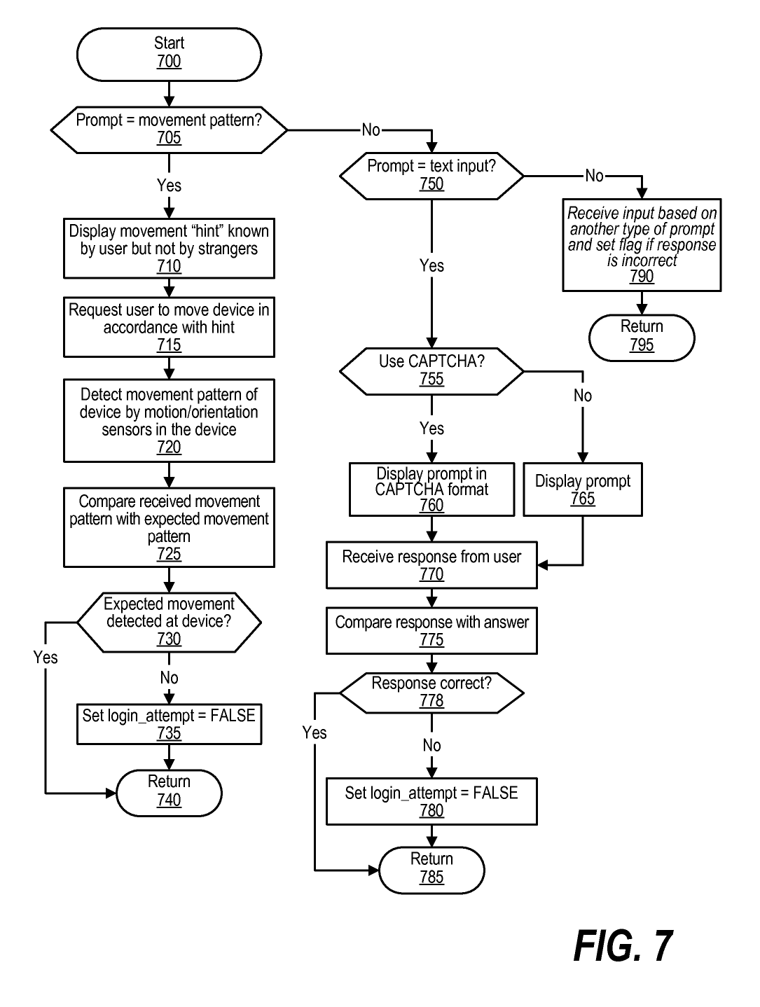

At step 570, the first prompt to be used and its expected response are retrieved from memory area 460 which is a memory inaccessible from outside of the restricted resource. At predefined process 580, the selected prompt is displayed to user 420 and a response is received from the user (see FIGS. 6 and 7 and corresponding text for processing details). During predefined process 580, the login_attempt flag is set to “FALSE” if any of the responses provided by the user are incorrect. At step 590, the process increments the prompt counter and processing loops back to decision 560 where the prompt counter is compared to the number of additional prompts. The looping continues until the prompt counter is equal to the number of additional prompts that are used for the current number of failed sign-on attempts, then decision 560 branches to the “yes” branch whereupon, at step 595, processing returns the login_attempt flag to the calling routine (see FIG. 4 for handling of the returned login_attempt flag).

FIG. 6 is a flowchart depicting steps taken at the device to display a selected prompt and receive a response from the user. Processing commences at 600 whereupon a decision is made as to whether the prompt is a biometric prompt (decision 605). If the prompt is a biometric prompt, then decision 605 branches to the “yes” branch to receive the biometric response. At step 610, a biometric prompt is displayed to the user requesting biometric identification data from the user, such as a fingerprint using a fingerprint scanner, a voiceprint using a microphone, a facial image using a digital camera, etc. At step 615, biometric input is received from the user. At step 620, the received biometric input is compared to an expected biometric input. A decision is made as to whether the received biometric input matches the expected biometric input (decision 625). If the received biometric input does not match the expected biometric input, then decision 625 branches to the “no” branch whereupon, at step 630, the flag (login_attempt) is set to “FALSE” indicating that the user provided an incorrect response. On the other hand, if the response matches, then decision 625 branches to the “yes” branch bypassing step 630 and processing returns to the calling routine (see FIG. 5) at 635. Note that the flag is not set to “TRUE” in response to a correct response because another response, such as the password attempt, may have been incorrect and thus already causing the flag to be set to “FALSE”.

Returning to decision 605, if the prompt is not for a biometric input, then decision 605 branches to the “no” branch for further processing. A decision is made as to whether the prompt is for an external tag prompt, such as an RFID tag (decision 640). If the response calls for an external tag, then decision 640 branches to the “yes” branch for further processing. At step 645, a prompt is displayed on the display screen requesting the user provide a physical device that supplies the external tag data, such as an RFID tag embedded in a ring, etc. At step 650, the system attempts to read the external tag data using a tag reader, such as an RFID reader. A decision is made as to whether external tag data was read by the external tag reader (decision 655). If no external tag data was able to be read, then decision 655 branches to the “no” branch whereupon, at step 670, the flag (login_attempt) is set to “FALSE” indicating an incorrect response to a prompt.

On the other hand, if external tag data was read by the external tag reader, then decision 655 branches to the “yes” branch whereupon, at step 660, the external tag data that was read is compared with expected external tag data. A decision is made as to whether the external tag data corresponds to the expected external tag data (decision 665). If incorrect external tag data was provided, then decision 665 branches to the “no” branch whereupon, at step 670, the flag (login_attempt) is set to “FALSE” indicating that the user provided an incorrect response. On the other hand, if the correct external tag data was provided by the user, then decision 665 branches to the “yes” branch bypassing step 670 and processing returns to the calling routine (see FIG. 5) at 675. Again, note that the flag is not set to “TRUE” in response to a correct response because another response, such as the password attempt, may have been incorrect and thus already causing the flag to be set to “FALSE”.

If the prompt is not a prompt for biometric data or external tag (RFID) data, then decision 640 branches to the “no” branch whereupon, at predefined process 680, additional prompt types are processed (see FIG. 7 and corresponding text for processing details). Processing then returns to the calling routine (see FIG. 5) at 695.

FIG. 7 is a flowchart depicting steps taken at the device to display additional prompts and receive corresponding responses from the user. Processing commences at 700 whereupon a decision is made as to whether the prompt is for a movement pattern, such as shaking or moving a mobile information handling system in a particular pattern (decision 705). If the prompt is for a movement pattern, then decision 705 branches to the “yes” branch for further processing.

At step 710, a movement pattern suggestion, or “hint”, is displayed to the user. Ideally, the movement suggestion is known by the user but not by strangers (e.g., “How do you like your martini?”). At step 715, the user is requested to move the device in a pattern that coincides with the movement suggestion. At step 720, movement of the device is detected (e.g., using a movement detector, such as an accelerometer, etc., incorporated in the device). At step 725, the received movement pattern of the device is compared to an expected movement pattern. A decision is made as to whether the received movement pattern of the device matches the expected movement pattern (decision 730). If the received movement pattern of the device does not match the expected movement pattern, then decision 730 branches to the “no” branch whereupon, at step 735, the flag (login_attempt) is set to “FALSE” indicating that the user provided an incorrect response. On the other hand, if the received movement pattern of the device matches the expected movement pattern then decision 730 branches to the “yes” branch which bypasses step 735. Processing returns to the calling routine (see FIG. 6) at 740. Note that the flag is not set to “TRUE” in response to a correct response because another response, such as the password attempt, may have been incorrect and thus already causing the flag to be set to “FALSE”.

Returning to decision 705, if the prompt was not to request a movement pattern, then decision 705 branches to the “no” branch whereupon a decision is made (decision 750) as to whether the prompt is for text input (e.g., provided at a keypad, using voice recognition, etc.). If the prompt is for a textual input, then decision 750 branches to the “yes” branch for further processing.

A decision is made as to whether the text input is to use a CAPTCHA (decision 755). A common type of CAPTCHA requires the user to type letters or digits from a distorted image that appears on the screen. If the text input uses a CAPTCHA, then decision 755 branches to the “yes” branch whereupon, at step 760, the prompt is displayed in the CAPTCHA (e.g., distorted, etc.) format. On the other hand, if CAPTCHA is not used for the prompt, then decision 755 branches to the “no” branch whereupon, at step 765, the prompt, such as a question known only by the user, is displayed in normal (e.g., non-distorted) format. At step 770, a response is received from the user. At step 775, the received response is compared to an expected response. A decision is made as to whether the received response matches the expected response (decision 778). If the received response does not match the expected response, then decision 778 branches to the “no” branch whereupon, at step 780, the flag (login_attempt) is set to “FALSE” indicating that the user provided an incorrect response. On the other hand, if the received response matches the expected response, then decision 778 branches to the “yes” branch which bypasses step 780. Processing returns to the calling routine (see FIG. 6) at 785. Again, note that the flag is not set to “TRUE” in response to a correct response because another response, such as the password attempt, may have been incorrect and thus already causing the flag to be set to “FALSE”.

Returning to decision 750, if the prompt is not a prompt for textual data, then decision 750 branches to the “no” branch whereupon, at step 790, input is received from the user based on some other type of prompt and the flag (login_attempt) is set to “FALSE” if the response provided by the user is incorrect. Processing returns to the calling routine (see FIG. 6) at 795.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, any suitable combination of the foregoing, or a future developed computer readable storage medium. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The connection may be physical or wireless.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method implemented by an information handling system comprising:
displaying a password prompt at a user interface of the information handling system, wherein providing a correct password is a sign-on barrier to a restricted resource;
allowing access to the restricted resource in response to receiving a correct password at the password prompt;
adding a plurality of additional sign-on barriers in response to receiving a plurality of consecutive incorrect passwords at the password prompt, wherein the adding further comprises determining the plurality of additional sign-on barriers based on a number of consecutive incorrect passwords;
receiving a plurality of subsequent responses to the plurality of additional sign-on barriers, wherein each of the subsequent responses is compared to an expected response;
in response to the comparisons:
denying access to the restricted resource in response to at least one of the subsequent responses failing to match the subsequent response's expected response; and
allowing access to the restricted resource in response to the subsequent responses matching the expected responses.

2. (canceled)

3. The method of claim 1, wherein the additional sign-on barriers include one or more additional prompts, the method further comprising:
displaying the password prompt and the one or more additional prompts at the user interface; and
receiving a subsequent password response corresponding to the password prompt and one or more additional responses that correspond to the one or more additional prompts, wherein the subsequent responses include the subsequent password response and the additional responses.

4. (canceled)

5. The method of claim 3 wherein at least one of the additional prompts is a CAPTCHA prompt.

6. The method of claim 3 wherein the additional prompts are included in a plurality of prompts, and wherein at least one of the plurality of prompts is a biometric prompt, the method further comprising:
receiving a biometric input in response to the biometric prompt, wherein the biometric input is one of the additional responses.

7. The method of claim 3 wherein the additional prompts are included in a plurality of prompts, and wherein at least one of the plurality of prompts is an external tag prompt, the method further comprising:
reading, using a tag reader, an external tag in response to the external tag prompt, the reading resulting in a reception of external tag data, wherein the received external tag data is one of the additional responses.

8. The method of claim 7 wherein the external tag is an RFID tag and wherein the tag reader is an RFID reader.

9. The method of claim 3 wherein the additional prompts are included in a plurality of prompts, and wherein at least one of the plurality of prompts is a movement pattern suggestion, the method further comprising:
receiving, using a movement sensor, a movement pattern of a device in response to the movement pattern suggestion, wherein the received movement pattern is one of the additional responses.

10. An information handling system comprising:
one or more processors;
a memory coupled to at least one of the processors;
an input device accessible by at least one of the processors;
a display device accessible by at least on of the processors; and
a set of instructions stored in the memory and executed by at least one of the processors, wherein the set of instructions perform actions of:
displaying, on the display, a password prompt at a user interface, wherein providing a correct password is a sign-on barrier to a restricted resource;
allowing access to the restricted resource in response to receiving a correct password at the password prompt;
adding a plurality of additional sign-on barriers in response to receiving a plurality of consecutive incorrect passwords at the password prompt, wherein the adding further comprises determining the plurality of additional sign-on barriers based on a number of consecutive incorrect passwords;
receiving a plurality of subsequent responses to the plurality of additional sign-on barriers, wherein each of the subsequent responses is compared to an expected response;
in response to the comparisons:
denying access to the restricted resource in response to at least one of the subsequent responses failing to match the subsequent response's expected response; and
allowing access to the restricted resource in response to the subsequent responses matching the expected responses.

11. (canceled)

12. The information handling system of claim 10, wherein the additional sign-on barriers include one or more additional prompts, and wherein the actions further comprise:
displaying the password prompt and the one or more additional prompts at the user interface; and
receiving a subsequent password response corresponding to the password prompt and one or more additional responses that correspond to the one or more additional prompts, wherein the subsequent responses include the subsequent password response and the additional responses.

13. (canceled)

14. The information handling system of claim 12 wherein at least one of the additional prompts is a CAPTCHA prompt.

15. The information handling system of claim 12 wherein the additional prompts are included in a plurality of prompts, and wherein at least one of the plurality of prompts is a biometric prompt, and wherein the actions further comprise:
receiving a biometric input in response to the biometric prompt, wherein the biometric input is one of the additional responses.

16. The information handling system of claim 12 wherein the additional prompts are included in a plurality of prompts, wherein at least one of the plurality of prompts is an external tag prompt, and wherein the actions further comprise:
reading, using a tag reader, an external tag in response to the external tag prompt, the reading resulting in a reception of external tag data, wherein the received external tag data is one of the additional responses.

17. The information handling system of claim 12 wherein the additional prompts are included in a plurality of prompts, wherein at least one of the plurality of prompts is a movement pattern suggestion, and wherein the actions further comprise:
receiving, using a movement sensor, a movement pattern of a device in response to the movement pattern suggestion, wherein the received movement pattern is one of the additional responses.

18. A computer program product stored in a computer readable storage device, comprising computer instructions that, when executed by an information handling system, cause the information handling system to perform actions comprising:
displaying a password prompt at a user interface of the information handling system, wherein providing a correct password is a sign-on barrier to a restricted resource;
allowing access to the restricted resource in response to receiving a correct password at the password prompt;
adding a plurality of additional sign-on barriers in response to receiving a plurality of consecutive incorrect passwords at the password prompt, wherein the adding further comprises determining the plurality of additional sign-on barriers based on a number of consecutive incorrect passwords;
receiving a plurality of subsequent responses to the plurality of additional sign-on barriers, wherein each of the subsequent responses is compared to an expected response;
in response to the comparisons:
denying access to the restricted resource in response to at least one of the subsequent responses failing to match the subsequent response's expected response; and
allowing access to the restricted resource in response to the subsequent responses matching the expected responses.

19. (canceled)

20. The computer program product of claim 18, wherein the additional sign-on barriers include one or more additional prompts, and wherein the computer instructions perform additional actions comprising:
displaying the password prompt and the one or more additional prompts at the user interface; and
receiving a subsequent password response corresponding to the password prompt and one or more additional responses that correspond to the one or more additional prompts, wherein the subsequent responses include the subsequent password response and the additional responses.

21. (canceled)

22. The computer program product of claim 20 wherein at least one of the additional prompts is a CAPTCHA prompt.

23. The computer program product of claim 20 wherein the additional prompts are included in a plurality of prompts, wherein at least one of the plurality of prompts is a biometric prompt, and wherein the computer instructions perform additional actions comprising:
receiving a biometric input in response to the biometric prompt, wherein the biometric input is one of the additional responses.

24. The computer program product of claim 20 wherein the additional prompts are included in a plurality of prompts, wherein at least one of the plurality of prompts is an external tag prompt, and wherein the computer instructions perform additional actions comprising:
reading, using a tag reader, an external tag in response to the external tag prompt, the reading resulting in a reception of external tag data, wherein the received external tag data is one of the additional responses.

25. The computer program product of claim 20 wherein the additional prompts are included in a plurality of prompts, wherein at least one of the plurality of prompts is a movement pattern suggestion, and wherein the computer instructions perform additional actions comprising:
receiving, using a movement sensor, a movement pattern of a device in response to the movement pattern suggestion, wherein the received movement pattern is one of the additional responses.
